(19) United States
(12) Patent Application Publication
(10) Pub. No.: US 2013/0248755 A1
(43) Pub. Date: Sep. 26, 2013

(54) HIGH DURABILITY THERMALLY CONDUCTIVE COMPOSITE AND LOW DE-OIOLING GREASE

(71) Applicant: DENKI KAGAKU KOGYO KABUSHIKI KAISHA, Tokyo (JP)

(72) Inventors: Takashi DOHMOTO, Shibukawa-city (JP); Kazuhiro OSHIMA, Shibukawa-city (JP); Toshitaka YAMAGATA, Shibukawa-city (JP)

(73) Assignee: DENKI KAGAKU KOGYO KABUSHIKI KAISHA, Tokyo (JP)

(21) Appl. No.: 13/892,348

(22) Filed: May 13, 2013

Related U.S. Application Data
(63) Continuation of application No. PCT/JP2011/076724, filed on Nov. 18, 2011.

(30) Foreign Application Priority Data
Nov. 18, 2010 (JP) 2010-258325
Apr. 20, 2011 (JP) 2011-094257

(51) Int. Cl. C09K 5/00

(52) U.S. Cl. CPC C09K 5/00
USPC 252/75

(57) ABSTRACT

Provided is a high durability thermally conductive composite containing 0.5-10 volume % of a high molecular weight silicone with vinyl groups on both ends with viscosity at 25 DEG C. of 10000-15000 Pa·s, 1-10 volume % of an alkylalkoxysilane, and 40-65 volume % of an inorganic filler with the remainder being an addition-reacting low molecular weight silicone with viscosity at 25 DEG C. of 0.2-0.5 Pa·s. Also provided is a grease characterized in containing 38-48 volume % of an addition-reacting low molecular weight silicone with viscosity at 25 DEG C. of 0.2-0.5 Pa·s, 2-8 volume % of a high molecular weight silicone with vinyl groups on both ends with viscosity at 25 DEG C. of 10000-15000 Pa·s, and 50-60 volume % of an inorganic filler. It is preferable that the alkylalkoxysilane is a triethoxysilane or trimethoxysilane wherein the number of carbons in the alkyl groups is six to ten.

### CROSS REFERENCE TO RELATED APPLICATIONS

This application is based upon and claims the benefit of priority from the prior Japanese Patent Application No. 2010-258325, filed on Nov. 18, 2010, Japanese Patent Application No. 2011-094257 filed on Apr. 20, 2011 and PCT International Application PCT/JP2011/076724, filed on Nov. 18, 2011, the entire contents of which are incorporated herein by reference.

### FIELD

The present invention is related to a thermally conductive material and a grease.

### BACKGROUND

The amount of heat per unit area produced from heat producing electronic components such as the CPU (central processing unit) of a personal computer has grown considerably with the increased small scale and high output of such components. The amount of heat from such components reaches about 20 times that of an iron. It is necessary to cool heat producing electronic components in order to ensure that such heat producing electronic components do not break over long periods of time. A metal heat sink or chassis is used for cooling and a thermally conductive material is further used for transferring heat efficiently to a cooling part such as the heat sink or the chassis from heat producing electronic components. A reason for using this thermally conductive material is that when the interface between a heat producing electronic component and a heat sink etc which are directly contacted together is viewed microscopically, air exists which is obstacle to thermal conductivity. Therefore, by providing a thermally conductive material between a heat producing electrical component and a heat sink etc instead of the air which exists at the contact interface between them, it is possible to efficiently transfer heat.

A thermally conductive sheet comprised from a hardened material in which thermally conductive powder is filled into high molecular silicon or low molecular silicon, a thermally conductive pad comprised from a hardened material having flexibility in which thermally conductive powder is filled into a soft silicon such as a low molecular silicon, a flowable grease in which thermally conductive powder is filled into a liquid silicon, and a phase-change thermally conductive material which softens or fluidizes at an operation temperature of heat producing electronic components are available as a thermally conductive material. Among these, the grease in particular can easily transfer heat. Details of regarding a thermally conductive grease are described in various document, for example, Japanese Laid Open Patent No. 2000-169873, Japanese Laid Open Patent No. 2002-194379, Japanese Laid Open Patent No. 2005-54099, International Patent Publication No. WO/2008/047809 and Japanese Laid Open Patent No. 2009-185212.

Grease is formed by containing thermally conductive powder in a base oil which is a liquid silicon such as silicon oil or a low-viscosity silicon such as a low molecular silicon.

In the case where alumina powder (Japanese Laid Open Patent No. 2005-170971) is filled into a base oil which is a dimethyl silicon oil, although having high thermal conductivity when it is used repeatedly over a long period of a heat cycle of low temperature and high temperature the silicon oil component which is the base oil is separated, i.e. “de-oiling” is occurred and thus thermal resistance increases. In addition, “de-oiling” occur more easily the lower viscosity grease and it is very difficult to develop a grease which has low viscosity and is difficult to de-oil.

However, while the use of a unique silicon has been proposed (Japanese Laid Open Patent No. 2004-91743) to solve the separation of a low molecular silicon component which is a base oil, preventing de-oiling by filling a high molecular silicon is not disclosed in this document. However, when too much high molecular silicon is filled, fluidity decreases significantly. In addition, preventing de-oiling by adding alkylalkoxysilane is also not disclosed. However, when too much alkylalkoxysilane is added, unreacted alkylalkoxysilane or methanol or ethanol which is produced by a reaction vaporizes due to heat and the out gas component increases, it is not desirable. In addition, the fluidity decreases significantly.

In addition, a coated grease is cracked or problems arise such as wide spreading of the grease because de-oiling of the grease which easily de-oils is accelerated by a heat cycle when a heat cycle test is performed, and then an air layer is formed at the coated part, thus thermal conduction properties worsen.

### SUMMARY

An aim of the present invention is to provide a high durability thermally conductive composite which can reduce de-oiling and has excellent heat cycle resistance and a low heat resistance. The high durability thermally conductive composite of the present invention is particularly suited to a grease.

In addition, an aim of the present invention is to provide a grease with reduced de-oiling and a low heat resistance.

The present invention adopts the following method for solving the problems described above.

(1) A high durability thermally conductive composite including 0.5˜10% by volume of a high molecular weight silicon with vinyl groups on both ends and with viscosity at 25° C. of 10000˜15000 Pa·s, 1˜10% by volume of an alkylalkoxysilane, 40˜65% by volume of an inorganic filler and the remainder of an addition-reacting low molecular weight silicon with viscosity at 25° C. of 0.2˜0.5 Pa·s.
(2) The high durability thermally conductive composite described in (1), wherein the alkylalkoxysilane is a triethoxysilane or trimethoxysilane having an alkyl group with 6 to 10 carbons.
(3) A grease using the high durability thermally conductive composite described in (1) or (2).
(4) A grease including 38˜48% by volume of an addition-reacting low molecular weight silicon with viscosity at 25° C. of 0.2˜0.5 Pa·s, 2˜8% by volume of a high molecular weight silicon with vinyl groups on both ends and with viscosity at 25° C. of 10000˜15000 Pa·s, and 50˜60% by volume of an inorganic filler.
(5) The grease described in (4), wherein the inorganic filler has frequency maximal values in a particle diameter range of 2.0˜10 μm and 0.1˜0.9 μm in a particle size distribution.
(6) The grease described in (4) or (5), wherein the contained ratio of two types of inorganic filler with different average particles diameters is 60˜70% by volume for an inorganic filler with an average particle diameter of 2.0˜10 μm, and 30˜40% by volume for another inorganic filler with an average particle diameter of 0.1˜0.9 μm when the inorganic filler has a % volume of 100.
(7) The grease described in (4) or (5), wherein viscosity is 250 Pa·s or less.

The high durability thermally conductive composite and grease of the present invention has excellent heat cycle resistance, low heat resistance and low de-oiling.

### BRIEF EXPLANATION OF THE DRAWINGS

FIG. 1 shows an exemplary diagram of a test jig in a heat cycle resistance evaluation experiment.

FIG. 2 shows an index example of porosity of a test sample after a heat cycle resistance evaluation experiment

FIG. 3 shows a measurement example of porosity of a test sample after a heat cycle resistance evaluation experiment FIG. 4 shows an exemplary example (side face view) for explaining a heat cycle experiment method.

FIG. 5 shows a de-oiling state of a grease (example).

FIG. 6 shows a de-oiling state of a grease (comparative example).

FIG. 7 shows a de-oiling state of the base oil component of a grease.

### DESCRIPTION OF EMBODIMENTS

A low molecular weight silicon and a high molecular weight silicon are used together as the silicon component in the high durability thermally conductive composite and the grease of the present invention.

An addition-reacting low molecular weight silicon with viscosity at 25° C. of 0.2˜0.5 Pa·s is used as the low molecular weight silicon.

When the viscosity of the addition-reacting low molecular weight silicon is lower than this, de-oiling tends to occur. When the viscosity of the addition-reacting low molecular weight silicon is higher than this, the viscosity of the high durability thermally conductive composite and that of the grease increase and the thermal conductivity of the high durability thermally conductive composite and that of the grease degrade since it is impossible to fill the filler to a high degree. Furthermore, the addition-reacting low molecular weight silicon as a component of the grease of the present invention is preferred to have a viscosity at 25° C. of 0.3˜0.5 Pa·s.

A high molecular weight silicon with vinyl groups on both ends and with viscosity at 25° C. of 10000˜15000 Pa·s is used as the high molecular weight silicon. When the viscosity of the high molecular weight silicon with vinyl groups on both ends is lower than this, degradation in heat resistance of the high durability thermally conductive composite and of grease easily occurs when a heat cycle is performed. In addition, de-oiling also easily occurs. Furthermore, when the viscosity of the high molecular weight silicon with vinyl groups on both ends is higher than this, the viscosity of the high durability thermally conductive composite and that of the grease increase and the filler can no longer be filled to a high degree.

The contained amount of the high molecular weight silicon with vinyl groups on both ends and with viscosity at 25° C. of 10000˜15000 Pa·s is 0.5˜10% by volume and more preferably 1˜10% by volume. When the contained amount of the high molecular weight silicon with vinyl groups on both ends is lower than 0.5% by volume, de-oiling easily occurs. When the contained amount of the high molecular weight silicon with vinyl groups on both ends is higher than 10% by volume, the viscosity of the high durability thermally conductive composite and that of the grease increase and the filler can no longer be filled to a high degree. Furthermore, a more preferable amount of the high molecular weight silicon with vinyl groups on both ends contained in the grease of the present invention is 2˜8% by volume. If the contained amount of the high molecular weight silicon with vinyl groups on both ends within the grease composition is 2˜8% by volume, it is possible to manufacture a grease having the effects of the present invention described above without including alkylalkoxysilane described below.

A one-component reaction type organopolysiloxane including both a vinyl group and a H—Si group in one molecule, or a two-component silicone comprising an organopolysiloxane including at least one of vinyl groups on one or both ends or a side chain and an organopolysiloxane including two or more H—Si groups on one or both ends or a side chain are specific examples of the addition-reacting low molecular weight silicon used in the present invention. For example, product name [SE-1886A/B] manufactured by Dow Corning Toray Silicone Co., Ltd is available.

The addition-reacting low molecular weight silicon used in the present invention is an organopolysiloxane with a weight-average molecular weight of 10000˜30000, in particular, an organopolysiloxane with a weight-average molecular weight of 15000˜25000 is preferred. When the weight-average molecular weight of the low molecular weight silicon is less than 10000, it is difficult to form a resin composite, and when the weight-average molecular weight is more than 30000, the filling property of a heat conduction filler degrades and thermal conductivity tends to decrease.

A high molecular weight silicon with vinyl groups on both ends and with a weight-average molecular weight of 400000˜600000 is used as the high molecular weight silicon in the present invention. In particular, an organopolysiloxane containing vinyl groups with a weight-average molecular weight of 450000˜550000 is preferred to be used.

It is possible to express a silane coupling agent by the following general formula.

R²_{b}R³_{c}Si(OR⁴)_{4-(b+c)}

R² in the formula is an alkyl group with a carbon atomic number of 1˜15, for example, a methyl group, ethyl group, propyl group, hexyl group, nonyl group, decyl group, dodecyl group, and a tetradecyl group are available. In addition, R³ is a saturated or unsaturated univalent hydrocarbon with a carbon atomic number of 1˜8, for example, an alkyl group such as a methyl group, ethyl group, propyl group, hexyl group, and an octyl group, a cyclohexyl group such as a cyclopentyl group and a cyclohexyl group, an alkenyl group such as a vinyl group and an allyl group, an aryl group such as a phenyl group and a tolyl group, a aralkyl group such as a 2-phenylethyl group and a 2-methyl-2-phenylethyl group and a halogenated hydrocarbon such as a 3,3,3-trifluoropropyl group, a 2-(perfluorobutyl)ethyl group, a 2-(perfluorooctyl)ethyl group and a p-chlorophenyl are available. R⁴ is one or two or more alkyl group with a carbon atomic number of 1˜6 such as a methyl group, ethyl group, propyl group, butyl group, pentyl group and a hexyl group. b is an integer of 1˜3, c is an integer of 0˜2 and b+c is an integer of 1˜3.

The alkylalkoxysilane used in the present invention is preferred to be triethoxysilane or trimethoxysilane with R² described above is 6 to 10, for example, alkylalkoxysilane, Z6583, Z6586, Z6341, Z6210 manufactured by Dow Corning Toray Silicone Co., Ltd are available.

R⁴ described above is a saturated univalent hydrocarbon with a carbon atomic number of 1 or 2, for example, a methyl group or ethyl group and is preferably a methyl group or ethyl group in the case where R² above described has a carbon atomic number of 3 or less.

The above described b is an integer of 1˜3, more preferably 1. The above described c is an integer of 0˜2, more preferably 0.

The contained amount of alkylalkoxysilane used in the present invention is 1˜10% by volume and more preferably 1˜5% by volume. Although bleed out and heat cycle resistance of a high durability thermally conductive material improves when alkylalkoxysilane is used, the effects are small when the contained amount is less than 1% by volume. When the contained amount of alkylalkoxysilane exceeds 10% by volume, unreactive alkylalkoxysilane remains or a large amount of methanol or ethanol generated during a reaction is contained. Therefore, there is a large mass reduction caused by vaporization of the unreactive alkylalkoxysilane, methanol or ethanol due to heat leading to increasing an out gas component, thus it is undesirable.

The viscosity of a low molecular weight silicon is measured using a [digital viscometer DV-1] manufactured by Brookfield. Using a RV spindle set and a rotor No. 1, a container is used which allows the rotor No. 1 to enter and the silicon to enter up to a reference line. The rotor is immersed into the silicon and viscosity is measured at 25° C. at a rotation speed of 10 rpm.

A viscosity obtained by performing a measurement using a [PHYSICA MCR301] manufactured by Anton-Paar at 25° C. with a shear rate of 0.00001˜10 s⁻¹ is used as the viscosity of a high molecular weight silicon, the high durability thermally conductive composite and the grease. In particular, in the case of evaluating working properties such as print coating or discharge property of the grease, the lower viscosity evaluated with a high shear rate shows the better working properties of the grease and here viscosity is estimated at a shear rate of 10 s⁻¹.

Furthermore, an antioxidant, a metal corrosion inhibitor, and etc. may be added as necessary to the high durability thermally conductive composite and the grease of the present invention in addition to each of the components described above.

In the present invention, it is possible to use silica, alumina, boron nitride, aluminum nitride, zinc oxide, and etc. as the inorganic filler. Among these, using alumina, aluminum nitride or zinc oxide is preferred.

In the present invention, for example, 0.05˜0.2 parts by mass with respect to 100 parts by mass of grease of an adhesive such as [Resino Black] manufactured by Resino Color Industry Co., Ltd. may be added so that the physical properties of the grease are not adversely affected.

In the present invention, it is possible to improve the filling properties of a filler and form a thin film by using an inorganic filler having a frequency maximal value in a particle diameter range of 2.0˜10 μm and 0.1˜0.9 μm in a particle size distribution.

The inorganic filler having the frequency maximal value in the particle diameter range of 2.0˜10 μm and 0.1˜0.9 μm in the particle size distribution cab be obtained by mixing two different types of powder having an inorganic filler with an average particle diameter of 2.0˜10 μm and another inorganic filler with an average particle diameter of 0.1˜0.9 μm.

It is preferred that the inorganic filler with the average particle diameter of 2.0˜10 μm be in an average particle diameter range of 3˜6 μm. When the average particle diameter is larger than 10 μm, it is difficult to form a thin film. Reversely when the average particle diameter is smaller than 2.0 μm, filling properties degrade.

It is preferred that the inorganic filler with the average particle diameter of 0.1˜0.9 μm be in an average particle diameter range of 0.3˜0.7 μm. When the average particle diameter is larger than 0.9 μm, filling properties degrade. Meanwhile, when the average particle diameter is smaller than 0.1 μm, filling properties of the entire inorganic filler degrade.

It is necessary that the inorganic filler in the high durability thermally conductive composite by 40˜65% by volume, in particular 50˜55% by volume is preferred. If the total of the inorganic filler exceeds 65% by volume, the viscosity of the high durability thermally conductive composite increases. Meanwhile, if the amount of the filled inorganic filler is less than 40% by volume, the properties of a filler such as thermal conductivity are not sufficiently expressed and the thermal conduction rate of the high durability thermally conductive composite degrades.

Furthermore, according to the present invention, it is possible to manufacture a grease which does not contain the alkylalkoxysilane described above. If the volume of the inorganic filler within the grease is 50˜60% by volume, it is possible to manufacture the grease showing the effects of the present invention described above without containing alkylalkoxysilane and in particular, 50˜55% by volume is preferred. If the total amount of the inorganic filler exceeds 60% by volume, the viscosity of the grease increases. Meanwhile, if the amount of the filled inorganic filler is less than 50% by volume, the properties of a filler such as thermal conductivity are not sufficiently expressed and the thermal conduction rate of the grease degrades.

The contained ratio of the two types of inorganic filler with different average particle diameters is preferred to be 60˜70% by volume for an inorganic filler with the average particle diameter of 2.0˜10 μm, and 30˜40% by volume for another inorganic filler with the average particle diameter of 0.1˜0.9 μm when the inorganic filler has a 100% by volume. When the ratio of the inorganic filler with particles having the average particles diameter of 2.0˜10 μm is less than 30% by volume, the viscosity of the high durability thermally conductive composite and that of the grease increase. Meanwhile, when the ratio of the inorganic filler with particles having the average particles diameter of 2.0˜10 μm is more than 70% by volume, the filling properties of the inorganic filler degrade.

The high durability thermally conductive composite and the grease of the present invention can be manufactured by kneading the materials described above using an all-purpose mixer, a kneader or a hybrid mixer etc.

### (Examples and Comparative Examples of a High Durability Thermally Conductive Composite)

The silicon, inorganic filler, and alkoxysilane used in the present invention are shown in table 1, table 2 and table 3. High durability thermally conductive composites with different viscosities were manufactured by thermally kneading each source material in the ratios shown in table 4˜6 for 3 hours at 110° C. Furthermore, each of the viscosities was measured using the measuring method described above.

The heat resistance, viscosity, de-oiling diameter, heat cycle resistance property and mass reduction rate of each of the obtained high durability thermally conductive composites were evaluated and the results are shown in the tables 4˜6.

The average particle diameter was measured using a laser diffraction particle size distribution analyzer SALD-200 manufactured by Shimadzu Corp. Each of the evaluation samples were obtained by adding 500 cc of pure water and 5 g of a thermally conductive powder for evaluating to a glass beaker, mixing them using a spatula and then performing a dispersion process for 10 minutes using an ultrasonic cleaning device. A solution of the thermally conductive powder having undergone the dispersion process was added drop by drop to a sampling section of the device using a dropper. After waiting to be stable until the absorbance could be measured, the measurement was performed at a time in which the absorbance is stable. Particle distribution was calculated based on data of light intensity distribution of diffraction/scattering light due to the particles detected by a sensor using the laser diffraction particle size distribution analyzer. The average particle diameter was calculated by multiplying a relative particle weight (% difference) by a value of the particle diameter measured and dividing by the total relative particle weight (100%). Furthermore, the average particle diameter indicates the diameter of a particle.

As a measurement method of heat resistance of the high durability thermally conductive composites, a high durability thermally conductive composite was placed between a 1 cm² (1 cm×1 cm) tip of a rectangular copper jig in which a heater is buried and a 1 cm² (1 cm×1 cm) tip of a rectangular copper jig attached with a cooling fin, a load of 4 kg per square centimeter was applied and the sample and the copper jigs were adhered together. The sample amount was in a state in which the entire adhered surface is buried. 20 W was applied to the heater and maintained for 30 minutes, the temperature difference (° C.) of the copper jigs was measured and heat resistance was measured by the formula;

Heat resistance(° C./W)={temperature difference(° C.)/power(W)}.

As long as the sample has a heat resistance value of 0.2° C./W or less regarding the thermal conductivity of the high durability thermally conductive composite, the sample can be used without any problems.

The de-oiling state of the high durability thermally conductive composite was measured by placing 0.1 g pieces of the high durability thermally conductive composites on filter paper (100 CIRCLES 125 mm) manufactured by ADVANTEC TOYO, leaving them to rest for 150 hours in an environment at 135° C., observing seepage (de-oiling) of the high durability thermally conductive composites to the filter and measuring the diameter of the seepage component. In addition, the state of de-oiling of the base oil itself in the high durability thermally conductive composite was measured by first dissolving the high durability thermally conductive composite in a base of oil good solvent (toluene), separating the filler and base oil, extracting only the base oil component from the supernatant solution and drying sufficiently the toluene, after the drying, placing 0.1 g parts of the base oil respectively on the filter paper (100 CIRCLES 125 mm) manufactured by ADVANTEC TOY, leaving them to rest for 150 hours in an environment at 135° C., and measuring seepage (de-oiling) oh the base oil to the filter.

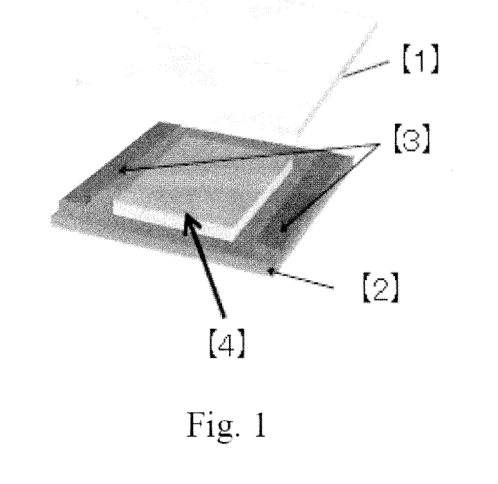

Using the jig shown in FIG. 1 the high durability thermally conductive composite was coated to a thickness of 100 um and 60 mm square on an aluminum plate, a glass plate was inserted therebetween, a heat cycle test was conducted from −40° C. to 125° C. and porosity of the sample was evaluated as an evaluation method of heat cycle resistance properties. The −40° C. and 125° C. temperatures were maintained for 30 minutes and the rise in temperature from −40° C. to 125° C. and drop in temperature from 125° C. to −40° C. were set to within 5 minutes. In the heat cycle resistance properties evaluation, the calculation method of porosity was as follows:

Porosity=area of pores/coating area of high durability thermally conductive composite×100(%)

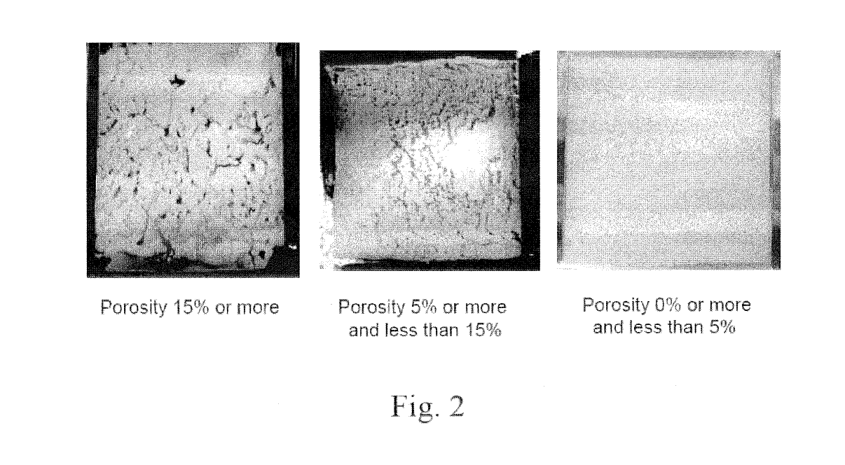

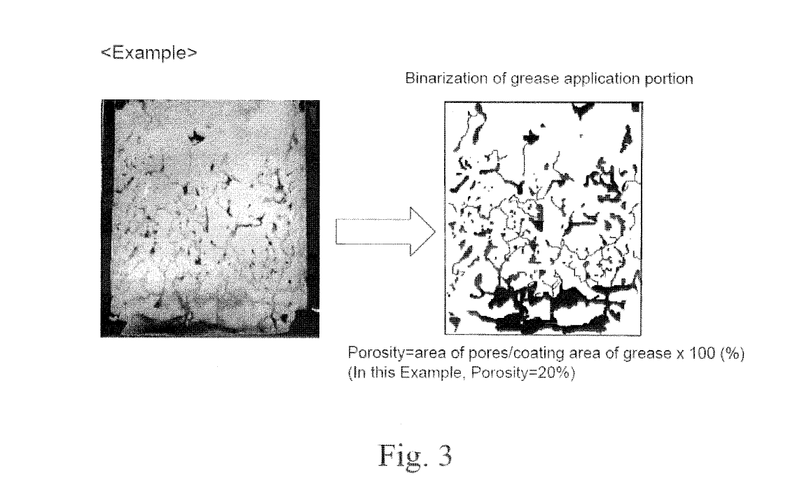

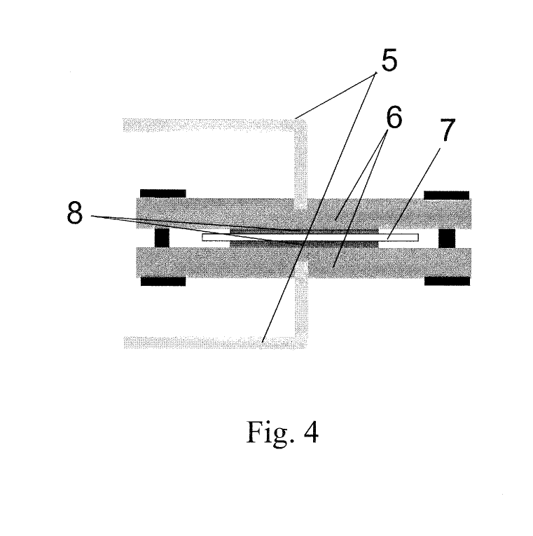

With regards to the porosity, a photograph of the sample after the heat cycle resistance evaluation test was taken using image processing software GIMP −2.0, the image was binarized into a pore section and high durability thermally conductive composite section and the area of each section was calculated. The porosity was evaluated as follows:
Porosity 0% or more and less than 5% is excellent (∘), Porosity 5% or more and less than 15% is good (Δ), Porosity 15% or more is poor (x) (see FIG. 2 and FIG. 3).

A reduction in mass was measured over 24 hours at 150° C. using a [TG-DTA2020SA] manufactured by Bruker AXS as an evaluation method of mass reduction of the high durability thermally conductive composite.

TABLE 1

| Type | Viscosity (Pa · s) |
|---|---|
| Addition-reacting low molecular weight silicon A | 0.1 |
| Addition-reacting low molecular weight silicon B | 0.2 |
| Addition-reacting low molecular weight silicon C | 0.35 |
| Addition-reacting low molecular weight silicon D | 0.5 |
| Addition-reacting low molecular weight silicon E | 1 |
| High molecular weight silicon with vinyl groups | 100 |
| on both ends A | |
| High molecular weight silicon with vinyl groups | 10000 |
| on both ends B | |
| High molecular weight silicon with vinyl groups | 12000 |
| on both ends C | |
| High molecular weight silicon with vinyl groups | 15000 |
| on both ends D | |
| High molecular weight silicon with vinyl groups | 100000 |
| on both ends E | |

TABLE 2

| | | Average particle |
|---|---|---|
| Category | Sample type | diameter (μm) |
| Inorganic filler A | Alumina powder | 2 |
| Inorganic filler B | Alumina powder | 0.5 |
| Inorganic filler C | Aluminum nitride powder | 2 |
| Inorganic filler D | Zinc oxide powder | 0.5 |

TABLE 3

| Category | Carbon number |
|---|---|
| Alkylalkoxysilane A | 3 |
| Alkylalkoxysilane B | 6 |
| Alkylalkoxysilane C | 8 |
| Alkylalkoxysilane D | 10 |
| Alkylalkoxysilane E | 12 |

TABLE 4

| | Examples | | | | | | | | | | |
|---|---|---|---|---|---|---|---|---|---|---|---|
| Material Category | C1 | C2 | C3 | C4 | C5 | C6 | C7 | C8 | C9 | C10 | C11 |
| Addition-reacting low molecular weight | C | C | C | C | C | C | C | C | C | B | D |
| silicon type | | | | | | | | | | | |
| Addition-reacting low molecular weight | 29 | 40 | 52 | 34 | 43 | 48 | 31 | 43 | 40 | 40 | 40 |
| silicon contained amount (% volume) | | | | | | | | | | | |
| High molecular weight silicon with vinyl | C | C | C | C | C | C | C | C | C | B | D |
| groups on both ends type | | | | | | | | | | | |
| High molecular weight silicon with vinyl | 3 | 4 | 5 | 10 | 1.0 | 9 | 2 | 3 | 2 | 4 | 4 |
| groups on both ends contained amount | | | | | | | | | | | |
| (% volume) | | | | | | | | | | | |
| Alkylalkoxysilane type | C | C | C | C | C | C | C | C | C | C | C |
| Alkylalkoxysilane contained amount | 3 | 3 | 3 | 3 | 3 | 3 | 2 | 1 | 5 | 3 | 3 |
| (% volume) | | | | | | | | | | | |
| Inorganic filler contained amount | 65 | 53 | 40 | 53 | 53 | 40 | 65 | 53 | 53 | 53 | 53 |
| (% volume) | | | | | | | | | | | |
| Inorganic filler A (% volume) | 45.5 | 37.1 | 28 | 37.1 | 37.1 | 28 | 45.5 | 37.1 | 37.1 | 37.1 | 37.1 |
| Inorganic filler B (% volume) | 19.5 | 15.9 | 12 | 15.9 | 15.9 | 12 | 19.5 | 15.9 | 15.9 | 15.9 | 15.9 |
| Inorganic filler C (% volume) | | | | | | | | | | | |
| Inorganic filler D (% volume) | | | | | | | | | | | |
| Heat resistance (K/W) | 0.10 | 0.10 | 0.12 | 0.10 | 0.10 | 0.12 | 0.10 | 0.10 | 0.10 | 0.10 | 0.10 |
| Viscosity (Pa · s, shear rate 10 s⁻¹) | 350 | 190 | 120 | 250 | 200 | 150 | 330 | 200 | 180 | 120 | 300 |
| De-oiling diameter (mm) | 0 | 0 | 7 | 0 | 7 | 6 | 0 | 7 | 0 | 7 | 0 |
| Heat cycle resistance properties | ◯ | ◯ | Δ | ◯ | Δ | Δ | ◯ | Δ | ◯ | Δ | ◯ |
| Mass reduction rate (%, heated over | 0.5% | 0.5% | 0.5% | 0.5% | 0.5% | 0.5% | 0.5% | 0.2% | 1.0% | 0.5% | 0.5% |
| 24 hr at 150° C.) | | | | | | | | | | | |

TABLE 5

| | Examples | | | | | |
|---|---|---|---|---|---|---|
| Material Category | C12 | C13 | C14 | C15 | C16 | C17 |
| Addition-reacting low molecular weight silicon type | C | C | C | C | C | C |
| Addition-reacting low molecular weight silicon contained | 40 | 40 | 40 | 40 | 40.5 | 30 |
| amount (% volume) | | | | | | |
| High molecular weight silicon with vinyl groups on | C | C | C | C | C | C |
| both ends type | | | | | | |
| High molecular weight silicon with vinyl groups on | 4 | 4 | 4 | 4 | 0.5 | 7 |
| both ends contained amount (% volume) | | | | | | |
| Alkylalkoxysilane type | B | D | C | C | C | C |
| Alkylalkoxysilane contained amount (% volume) | 3 | 3 | 3 | 3 | 3 | 10 |
| Inorganic filler contained amount (% volume) | 53 | 53 | 53 | 53 | 56 | 53 |
| Inorganic filler A (% volume) | 37.1 | 37.1 | 37.1 | | 39.2 | 37.1 |
| Inorganic filler B (% volume) | 15.9 | 15.9 | | 37.1 | 16.8 | 15.9 |
| Inorganic filler C (% volume) | | | | 15.9 | | |
| Inorganic filler D (% volume) | | | 15.9 | | | |
| Heat resistance (K/W) | 0.10 | 0.10 | 0.10 | 0.10 | 0.10 | 0.10 |
| Viscosity (Pa · s, shear rate 10 s⁻¹) | 200 | 200 | 190 | 190 | 210 | 400 |
| De-oiling diameter (mm) | 0 | 0 | 0 | 0 | 9 | 0 |
| Heat cycle resistance properties | ◯ | ◯ | ◯ | ◯ | Δ | Δ |
| Mass reduction rate (%, heated over 24 hr at 150° C.) | 0.5% | 0.5% | 0.5% | 0.5% | 0.5% | 2.0% |

TABLE 6

| | Comparative Examples | | | | | | |
|---|---|---|---|---|---|---|---|
| Material Category | C1 | C2 | C3 | C4 | C5 | C6 | C7 |
| Addition-reacting low molecular weight silicon type | C | C | C | C | C | C | C |
| Addition-reacting low molecular weight silicon contained amount | 19 | 56 | 42 | 40.9 | 50 | 30 | 39.9 |
| (% volume) | | | | | | | |
| High molecular weight silicon with vinyl groups on both ends type | C | C | C | C | C | C | C |
| High molecular weight silicon with vinyl groups on both ends contained | 3 | 2 | 15 | 0.1 | 10 | 2 | 7 |
| amount (% volume) | | | | | | | |
| Alkylalkoxysilane type | C | C | C | C | C | C | C |
| Alkylalkoxysilane contained amount (% volume) | 3 | 2 | 3 | 3 | 5 | 1 | 0.1 |
| Inorganic filler contained amount (% volume) | 75 | 40 | 40 | 56 | 35 | 67 | 53 |
| Inorganic filler A (% volume) | 52.5 | 28 | 28 | 39.2 | 24.5 | 46.9 | 37.1 |
| Inorganic filler B (% volume) | 22.5 | 12 | 12 | 16.8 | 10.5 | 20.1 | 15.9 |
| Inorganic filler C (% volume) | | | | | | | |
| Inorganic filler D (% volume) | | | | | | | |
| Heat resistance (K/W) | 0.10 | 0.12 | 0.12 | 0.10 | 0.25 | 0.10 | 0.10 |
| Viscosity (Pa · s, shear rate 10 s⁻¹) | 500 | 100 | 300 | 180 | 450 | 360 | 380 |
| De-oiling diameter (mm) | 0 | 15 | 10 | 12 | 9 | 10 | 9 |
| Heat cycle resistance properties | X | X | X | X | X | X | X |
| Mass reduction rate (%, heated over 24 hr at 150° C.) | 0.5% | 0.5% | 0.5% | 0.5% | 1.0% | 0.2% | 0.1% |
| | Comparative Examples | | | | | | |
| Material Category | C8 | C9 | C10 | C11 | C12 | C13 | C14 |
| Addition-reacting low molecular weight silicon type | C | A | E | C | C | C | C |
| Addition-reacting low molecular weight silicon contained amount | 25 | 40 | 40 | 40 | 40 | 40 | 40 |
| (% volume) | | | | | | | |
| High molecular weight silicon with vinyl groups on both ends type | C | C | C | A | E | C | C |
| High molecular weight silicon with vinyl groups on both ends contained | 7 | 4 | 4 | 4 | 4 | 4 | 4 |
| amount (% volume) | | | | | | | |
| Alkylalkoxysilane type | C | C | C | C | C | A | E |
| Alkylalkoxysilane contained amount (% volume) | 15 | 3 | 3 | 3 | 3 | 3 | 3 |
| Inorganic filler contained amount (% volume) | 53 | 53 | 53 | 53 | 53 | 53 | 53 |
| Inorganic filler A (% volume) | 37.1 | 37.1 | 37.1 | 37.1 | 37.1 | 37.1 | 37.1 |
| Inorganic filler B (% volume) | 15.9 | 15.9 | 15.9 | 15.9 | 15.9 | 15.9 | 15.9 |
| Inorganic filler C (% volume) | | | | | | | |
| Inorganic filler D (% volume) | | | | | | | |
| Heat resistance (K/W) | 0.10 | 0.10 | 0.10 | 0.10 | 0.10 | 0.10 | 0.10 |
| Viscosity (Pa · s, shear rate 10 s⁻¹) | 500 | 100 | 700 | 100 | 550 | 200 | 550 |
| De-oiling diameter (mm) | 0 | 20 | 0 | 20 | 0 | 10 | 0 |
| Heat cycle resistance properties | X | X | X | X | X | X | X |
| Mass reduction rate (%, heated over 24 hr at 150° C.) | 5.0% | 0.5% | 0.5% | 0.5% | 0.5% | 0.5% | 0.5% |

As is shown by the examples C1 to C17 and comparative examples C1 to C14, the high durability thermally conductive composite of the present invention has low de-oiling, excellent heat cycle resistance and low heat resistance.

### [Examples and Comparative Examples of Grease]

A variety of greases with different fluidities were manufactured by containing an inorganic filler and silicon in the ratios shown in table 7 and table 8 and thermally kneaded for 3 hours at 110° C. Furthermore, viscosity of the greases was measured using the same method as the measurement performed for the high durability thermally conductive composite described above. In addition, the viscosity of a high molecular weight silicon with vinyl groups on both ends described in the examples G1 to G14 and comparative examples G1 to G16 had an average value of 12000 Pa·s and actual viscosity in a range of 10000˜15000 Ps·a.

### 1) Inorganic Filler

(1) Alumina Powder average particle diameter (50% volume diameter) 2 μm
(2) Alumina Powder average particle diameter (50% volume diameter) 0.2 μm
(3) Aluminum Nitride Powder average particle diameter (50% volume diameter) 2 μm
(4) Zinc Oxide Powder average particle diameter (50% volume diameter) 0.2 μm

### 2) Silicon

(1) Silgel619 (viscosity 100 mPa·s)
(2) Silgel613 (viscosity 200 mPa·s)
(3) XE14-B8530 (viscosity 350 mPa·s)
(4) SE1885M (viscosity 500 mPa·s)
(5) SE1886 (viscosity 1000 mPa·s)
(6) TSE3032 (viscosity 4000 mPa·s)
(7) Silgel610 (viscosity 7000 mPa·s)
(8) SRH-32 (viscosity 12000 mPa·s)

Furthermore, the average particle diameter of the inorganic filler, viscosity of a low molecular weight silicon, and viscosity of a high molecular weight silicon and grease were measured using the same method as the measurement used for the high durability thermally conductive composite described above.

In addition, heat resistance and the de-oiling state of the grease were measured using the same method as the measurement used for the high durability thermally conductive composite described above.

A heat cycle test was conducted using the jig shown in FIG. 4 and heat resistance was evaluated by conducting a heat cycle test from −40° C. to 125° C. The −40° C. and 125° C. temperatures were maintained for 30 minutes and the rise in temperature from −40° C. to 125° C. and drop in temperature from 125° C. to −40° C. were set to within 5 minutes. The heat cycle test was conducted 3 times and the average resistance was evaluated as the heat resistance.

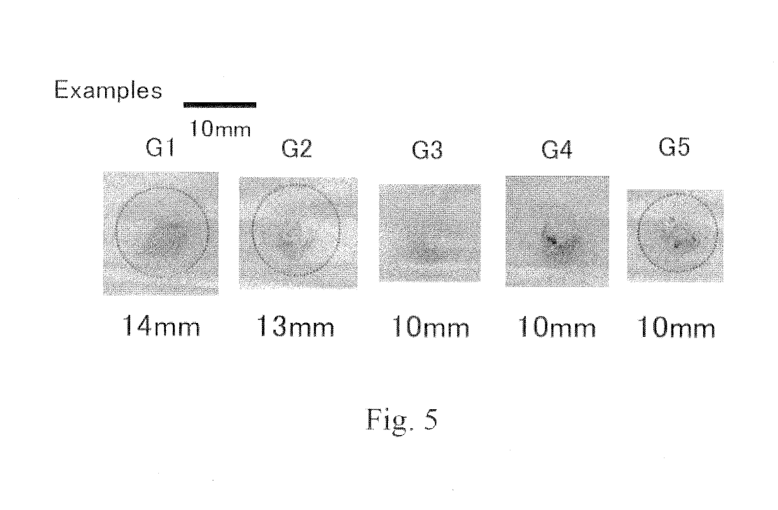

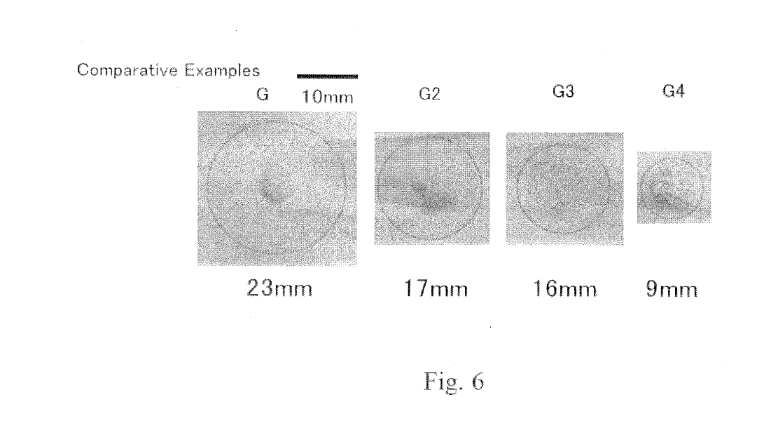

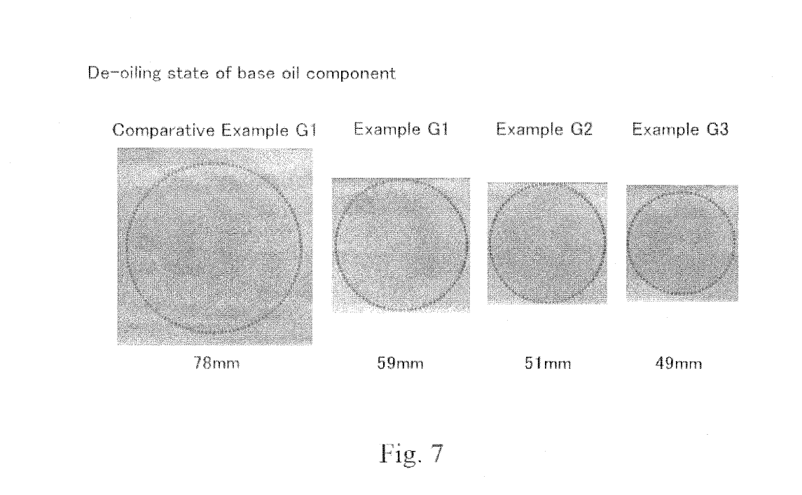

The results of evaluating the heat resistance and separation state of the obtained grease are shown in table 7 and table 8 and FIG. 5 and FIG. 6. In addition, the de-oiling state of only the base oil component of the grease is shown in FIG. 7. As is shown in FIG. 5˜FIG. 7, de-oiling of the grease decreases as a result of it becoming difficult for the base oil component to be de-oiled. In addition, de-oiling decreases regardless of the type of filler as is shown by the example G4, G5, G9 and G10.

In addition, a heat cycle test was conducted in example G1˜G3 and comparative example G1. The test was conducted 3 times and the heat resistance average value is shown in table 9.

TABLE 7

| | | | Examples (% Volume) | | | | | | |
|---|---|---|---|---|---|---|---|---|---|
| Material Category | | | G1 | G2 | G3 | G4 | G5 | G6 | G7 |
| Low molecular weight silicon | mPa · s | 350 | 47.5 | 45 | 42.5 | 42.5 | 42.5 | | |
| | | 500 | | | | | | 47.5 | 45 |
| High molecular weight silicon | Pa · s | 12000 | 2.5 | 5 | 7.5 | 7.5 | 7.5 | 2.5 | 5 |
| Inorganic filler contained amount | | | 50 | 50 | 50 | 50 | 50 | 50 | 50 |
| Coarse Alumina powder | μm | 2.0 | 35 | 35 | 35 | | 35 | 35 | 35 |
| Fine Alumina powder | μm | 0.2 | 15 | 15 | 15 | 15 | | 15 | 15 |
| Aluminum nitride | μm | 2.0 | | | | 35 | | | |
| Zinc oxide | μm | 0.2 | | | | | 15 | | |
| Heat resistance (K/W) | | | 0.10 | 0.10 | 0.10 | 0.10 | 0.10 | 0.10 | 0.10 |
| Viscosity Pa · s, shear rate 10 s⁻¹) | | | 120 | 160 | 230 | 230 | 230 | 140 | 180 |
| De-oiling diameter (mm) | | | 14 | 13 | 10 | 10 | 10 | 13 | 12 |
| | | | Examples (% Volume) | | | | | | |
| Material Category | | | G8 | G9 | G10 | G11 | G12 | G13 | G14 |
| Low molecular weight silicon | mPa · s | 350 | | | | 42.8 | 38.0 | | |
| | | 500 | 42.5 | 42.5 | 42.5 | | | 42.8 | 38.0 |
| High molecular weight silicon | Pa · s | 12000 | 7.5 | 7.5 | 7.5 | 2.25 | 2.00 | 2.25 | 2.00 |
| Inorganic filler contained amount | | | 50 | 50 | 50 | 55 | 60 | 55 | 60 |
| Coarse Alumina powder | μm | 2.0 | 35 | | 35 | 38.5 | 42.0 | 38.5 | 42.0 |
| Fine Alumina powder | μm | 0.2 | 15 | 15 | | 16.5 | 18.0 | 16.5 | 18.0 |
| Aluminum nitride | μm | 2.0 | | 35 | | | | | |
| Zinc oxide | μm | 0.2 | | | 15 | | | | |

| | | | | | | | |
|---|---|---|---|---|---|---|---|
| Heat resistance (K/W) | 0.10 | 0.10 | 0.10 | 0.10 | 0.10 | 0.10 | 0.10 |
| Viscosity Pa · s, shear rate 10 s⁻¹) | 250 | 250 | 250 | 160 | 230 | 180 | 250 |
| De-oiling diameter (mm) | 9 | 9 | 9 | 13.5 | 13.5 | 13 | 13 |

TABLE 8

| | | | Comparative Examples(% Volume) | | | | | | | |
|---|---|---|---|---|---|---|---|---|---|---|
| Material Category | | | G1 | G2 | G3 | G4 | G5 | G6 | G7 | G8 |
| Low molecular weight silicon | mPa · s | 100 | | | | | | | | |
| | | 200 | | | | | | | | |
| | | 350 | 45 | 49.5 | 48.7 | 40 | 42 | 44 | | |
| | | 500 | | | | | | | 42 | 44 |
| | | 1000 | | | | | | | | |
| | | 4000 | | | | | | | | |
| | | 7000 | | | | | | | | |
| High molecular weight silicon | Pa · s | 12000 | 0 | 0.5 | 1.3 | 10 | 10.5 | 11 | 10.5 | 11 |
| Inorganic filler contained amount | | | 55 | 50 | 50 | 50 | 47.5 | 45 | 47.5 | 45 |
| Coarse Alumina powder | μm | 2.0 | 16.5 | 35 | 35 | 35 | 33.3 | 31.5 | 33.3 | 31.5 |
| Fine Alumina powder | μm | 0.2 | 38.5 | 15 | 15 | 15 | 14.3 | 13.5 | 14.3 | 13.5 |
| Aluminum nitride | μm | 2.0 | | | | | | | | |
| Zinc oxide | μm | 0.2 | | | | | | | | |
| Heat resistance (K/W) | | | 0.10 | 0.10 | 0.10 | 0.10 | 0.14 | 0.16 | 0.14 | 0.16 |
| Viscosity (Pa · s, shear rate 10 s⁻¹) | | | 90 | 100 | 110 | 300 | 250 | 200 | 270 | 220 |
| De-oiling diameter (mm) | | | 30 | 23 | 20 | 9 | 10 | 10 | 9.5 | 9.5 |
| | | | Comparative Examples(% Volume) | | | | | | | |
| Material Category | | | G9 | G10 | G11 | G12 | G13 | G14 | G15 | G16 |
| Low molecular weight silicon | mPa · s | 100 | 45 | | | | | | 40 | |
| | | 200 | | 45 | | | | | | 40 |
| | | 350 | | | | | | | | |
| | | 500 | | | 45 | | | | | |
| | | 1000 | | | | 45 | | | | |
| | | 4000 | | | | | 45 | | | |
| | | 7000 | | | | | | 45 | | |
| High molecular weight silicon | Pa · s | 12000 | 0 | 0 | 0 | 0 | 0 | 0 | 10 | 10 |
| Inorganic filler contained amount | | | 55 | 55 | 55 | 55 | 55 | 55 | 50 | 50 |
| Coarse Alumina powder | μm | 2.0 | 16.5 | 16.5 | 16.5 | 16.5 | 16.5 | 16.5 | 15 | 15 |
| Fine Alumina powder | μm | 0.2 | 38.5 | 38.5 | 38.5 | 38.5 | 38.5 | 38.5 | 35 | 35 |
| Aluminum nitride | μm | 2.0 | | | | | | | | |
| Zinc oxide | μm | 0.2 | | | | | | | | |

| | | | | | | | | |
|---|---|---|---|---|---|---|---|---|
| Heat resistance (K/W) | 0.10 | 0.10 | 0.10 | 0.10 | 0.10 | 0.10 | 0.10 | 0.10 |
| Viscosity (Pa · s, shear rate 10 s⁻¹) | 80 | 85 | 100 | 200 | 300 | 500 | 200 | 270 |
| De-oiling diameter (mm) | 40 | 35 | 25 | 20 | 16 | 14 | 30 | 20 |

TABLE 9

| | Heat cycle number | | | |
|---|---|---|---|---|
| Sample category | 0 | 500 | 1000 | 2000 |
| Comparative Example G1 (K/W) | 0.94 | 1.04 | 1.14 | 1.28 |
| Example G1 (K/W) | 0.94 | 0.96 | 0.99 | 0.96 |
| Example G2 (K/W) | 0.94 | 0.99 | 0.99 | 0.95 |
| Example G3 (K/W) | 0.94 | 0.99 | 0.99 | 0.93 |

As is shown by the measurement results of the examples G1 to G14 and comparative examples G1 to G16, the grease of the present invention has low de-oiling and low heat resistance.

In addition, according to the measurement results in examples G1 to G3 and comparative example G1, the grease of the present invention has low degradation in a heat cycle. The reason for the amount of de-oiling decreasing in this way is assumed to be due to the amount of de-oiling of the base oil decreasing.

What is claimed is:

1. A high durability thermally conductive composite comprising:
0.5˜10% by volume of a high molecular weight silicon with vinyl groups on both ends and with viscosity at 25° C. of 10000˜15000 Pa·s, 1˜10% by volume of an alkylalkoxysilane, 40˜65% by volume of an inorganic filler, and the remainder of an addition-reacting low molecular weight silicon with viscosity at 25° C. of 0.2˜0.5 Pa·s.

2. The high durability thermally conductive composite according to claim 1, wherein the alkylalkoxysilane is a triethoxysilane or trimethoxysilane having an alkyl group with 6 to 10 carbons.

3. A grease using the high durability thermally conductive composite according to claim 1.

4. A grease using the high durability thermally conductive composite according to claim 2.

5. A grease comprising:
38˜48% by volume of an addition-reacting low molecular weight silicon with viscosity at 25° C. of 0.2˜0.5 Pa·s, 2˜8% by volume of a high molecular weight silicon with vinyl groups on both ends and with viscosity at 25° C. of 10000˜15000 Pa·s, and 50˜60% by volume of an inorganic filler.

6. The grease according to claim 5, wherein the inorganic filler has frequency maximal values in a particle diameter range of 2.0˜10 μm and 0.1˜0.9 μm in a particle size distribution.

7. The grease according to claim 5, wherein the contained ratio of two types of inorganic filler with different average particles diameters is 60˜70% by volume for an inorganic filler with an average particle diameter of 2.0˜10 μm, and 30˜40% by volume for another inorganic filler with an average particle diameter of 0.1˜0.9 μm when the inorganic filler has a % volume of 100.

8. The grease according to claim 6, wherein the contained ratio of two types of inorganic filler with different average particles diameters is 60˜70% by volume for an inorganic filler with an average particle diameter of 2.0˜10 μm, and 30˜40% by volume for another inorganic filler with an average particle diameter of 0.1˜0.9 μm when the inorganic filler has a % volume of 100.

9. The grease according to claim 5, wherein viscosity is 250 Pa·s or less.

10. The grease according to claim 6, wherein viscosity is 250 Pa·s or less.
